(19) United States
(12) Patent Application Publication
(10) Pub. No.: US 2005/0226102 A1
(43) Pub. Date: Oct. 13, 2005

(54) Dynamic copy window control for domain expansion reading

(75) Inventors: Albert Hendrik Jan Immink, Eindhoven (NL); Coen Adrianus Verschuren, Eindhoven (NL); Martinus Wilhelmus Blum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/517,925

(22) PCT Filed: Jun. 5, 2003
(86) PCT No.: PCT/IB03/02479

§ 371 Date: Dec. 14, 2004

(30) Foreign Application Priority Data
Jun. 17, 2002 (EP) 02077375.0

(51) Int. Cl. G11B 11/00

(52) U.S. Cl. 369/13.05

(57) ABSTRACT

Method and apparatus for reading a magneto-optical domain expansion recording medium (10), wherein the size of a spatial copy window of a domain copying process is controlled by varying a predetermined reading parameter in response to a control information derived from a readout pulse. A predetermined additional pattern of change is applied to said predetermined parameter and the control information is then derived from a deviation of a clock signal. The size of the copy window can thus be controlled dynamically to obtain a robust and reliable readout process.

The present invention relates to a method and apparatus for reading a domain expansion recording medium, such as a MAMMOS (Magnetic AMplifying Magneto-Optical System) disk, comprising a recording or storage layer and an expansion or readout layer.

In magneto-optical storage systems the minimum width of the recorded marks is determined by the diffraction limit, that is by the Numerical Aperture (NA) of the focusing lens and the laser wavelength. A reduction of the width is generally based on applying shorter wavelength lasers and higher NA focusing optics. During magneto-optical recording the minimum bit length can be reduced to below the optical diffraction limit by using Laser Pulsed Magnetic Field Modulation (LP-MFM). In LP-MFM the bit transitions are determined by the switching of the field and the temperature gradient induced by the switching of the laser.

FIG. 3 shows a typical pattern of crescent-shaped bits or recorded domains as formed in the recording layer by an LP-MFM recording with a width of 0.6 μm and a thickness of 0.2 μm. For readout of the small crescent-shaped marks recorded in this way Magnetic Super Resolution (MSR) or Domain Expansion (DomEx) methods have been proposed. These technologies are based on recording media with several magneto-static or exchange-coupled layers.

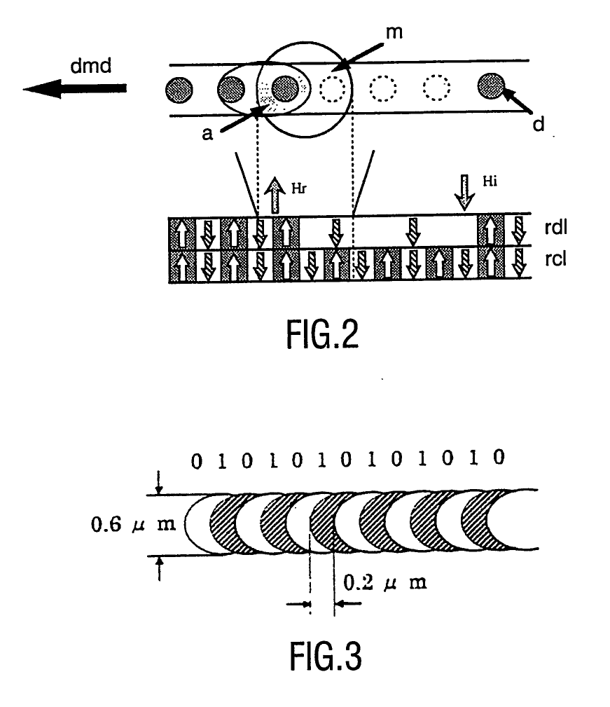

FIG. 2 shows a typical stack of a recording or storage layer rcl and of a readout layer rdl for such MSR media In FIG. 2, an arrow dmd indicates the disk moving direction. The readout layer rdl on a magneto-optical disk is arranged to mask adjacent bits during reading while, according to domain expansion, a domain d in the center of a spot m is expanded. The advantage of the domain expansion technique over MSR results in that bits with a length below the diffraction limit can be detected with a similar signal-to-noise ratio (SNR) as bits with a size comparable to the diffraction-limited spot size. MAMMOS is a domain expansion method based on magneto-statically coupled storage and readout layers wherein a magnetic field modulation is used for expansion and collapse of the expanded domains d in the readout layer rdl.

In the above-mentioned domain expansion techniques, like MAMMOS, a written mark from the storage layer rcl is copied to the readout layer rdl upon laser heating and with the help of an external magnetic field. Due to the low coercivity of this readout layer, the copied mark will expand to fill the optical spot and can be detected with a saturated signal level which is independent of the mark size. Reversal of the external magnetic field collapses the expanded domain. On the other hand, a space in the storage layer will not be copied and no expansion will occur. Therefore, no signal will be detected in this case.

To read out the bits or domains in the storage layer rcl, the thermal profile of the optical spot is used. When the temperature of the readout layer rdl is above a predetermined threshold value the magnetic domains are copied from the storage layer rcl to the magneto-statically coupled readout layer rdl. This is because the stray field H_{S} from the storage layer rcl, which is proportional to the magnetization of this layer, increases as a function of the temperature.

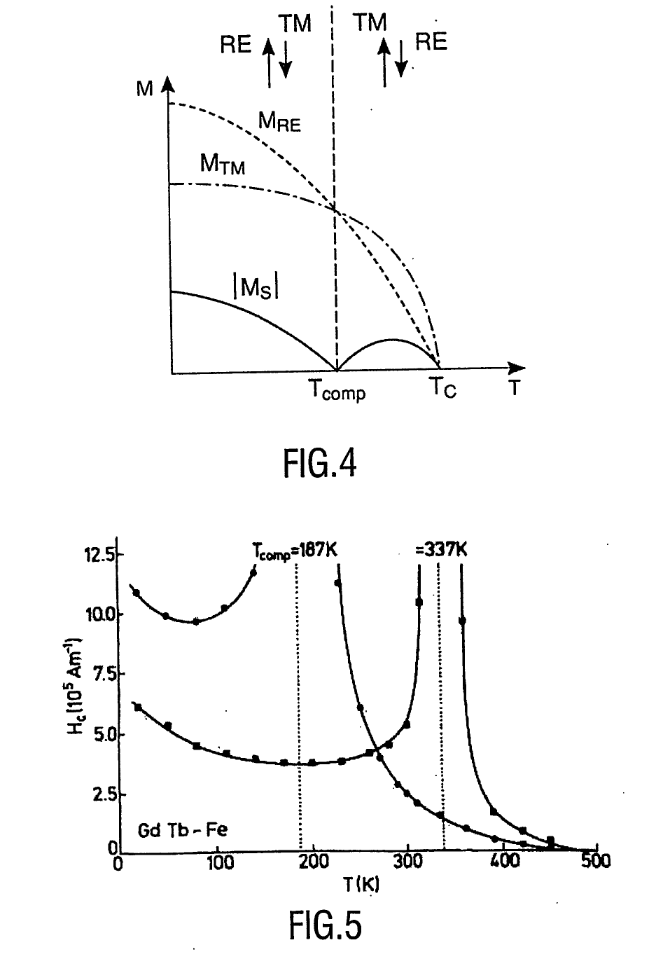

FIG. 4 shows a diagram indicating a characteristic of the magnetization M_{S} of the storage or recording layer as a function of the temperature. According to FIG. 4, the magnetization Ms increases as a function of the temperature for the temperature region just above a compensation temperature T_{comp}. This effect results from the use of a rare-earth transition metal (RE-TM) alloy which generates two counteracting magnetizations M_{RE} (rare earth component) and M_{TM} (transition metal component) with opposite directions.

FIG. 5 shows a diagram indicating the effect of the coercivity of the readout layer rdl as a function of the temperature. The coercivity of the readout layer rdl decreases as a function of the temperature in this region just above the compensation temperature T_{comp}. Two layers with a different compensation temperature are shown by way of example in FIG. 5.

By applying an external magnetic field the copied domain in the readout layer rdl expands to a saturated detection signal, independent of the size of the original domain. This copying process is non-linear. When the temperature is above the threshold value, magnetic domains are coupled from the storage layer rcl to the readout layer rdl. For temperatures above this threshold temperature the following condition is satisfied:
H_{S}+Hₑₓₜ≧H_{c} (1)
where H_{S} is the stray field of the storage layer rcl at the readout layer rdl, Hₑₓₜ is the external applied field and H_{c} is the coercive field of the readout layer rdl. The spatial region where this copying occurs is called the ‘copy window’ w. The size of this copy window w is very critical for accurate readout. When the condition (1) is not fulfilled (copy window w=0), no copying takes place at all. On the other hand, an oversized copy window w will cause overlap with neighboring bits (marks) and will lead to additional ‘interference peaks’. The size of the copy window w depends on the exact shape of the temperature profile (dependent, for example, on the laser power and on the ambient temperature), the strength of the external applied magnetic field, and on material parameters that may show range variations.

On the one hand, the laser power used in the readout process should be high enough to enable copying. On the other hand, a higher laser power increases the overlap of the temperature-induced coercivity profile and the stray field profile of the bit pattern. The coercivity H_{c} decreases and the stray field increases with increasing temperature. When the overlap becomes too large, correct readout of a space is no longer possible due to false signals generated by neighboring marks. The difference between this maximum allowed laser power and the minimally required laser power determines the so-called power margin. This power margin decreases with decreasing bit length. Experiments have shown that when applying current methods, bit lengths of 0.10 μm can be correctly detected at a small power margin of less than 1%. Therefore, for higher densities the power margin remains quite small so that optical power control during readout is very important.

Conventionally, that is, in phase change recording or conventional magneto-optic recording, the laser power during the read mode is controlled by a feedback loop that measures the laser output power using, for example a so called Forward Sense Diode (FSD). During writing, an additional running optimum power control method might be applied to provide absorption control; such a method, for example, uses the reflected light during the writing process.

However, the accuracy of these loops is not sufficient by far for robust readout of MAMMOS disks. For example, a change in the ambient temperature is generally not measured by the FSD, but it influences the copy window.

Another idea is to control the laser power by counting the number of detected MAMMOS pulses from a known sequence or calculating the running digital sum of a detected signal from a recorded DC free modulation code. In these cases, an insufficient laser power will result in a smaller number of pulses than expected, since no copying occurs in some cases. On the other hand, an excessive laser power will give more pulses than expected. A disadvantage of this kind of pulse-counting control methods is the fact that errors must be made deliberately to obtain an error signal.

It is an object of the present invention to provide a reading method and a reading apparatus for domain expansion readout by means of which a robust and reliable readout process can be achieved.

This object is achieved according to the present invention by providing a method as claimed in claim 1 and by providing an apparatus as claimed in claim 8.

Accordingly, a dynamic copy window control function is provided by using induced clock deviations as an input for a copy window control function. The accuracy of the copy window size is thus increased to improve robustness and reliability of the readout process.

The clock signal may be recovered from the readout pulse, from a wobbled groove, or from fine embossed clock marks provided in the disk, or from any combination thereof.

The predetermined parameter may correspond to the value of the radiation power. Alternatively, the predetermined parameter may correspond to the strength of the external magnetic field. In a further embodiment, the predetermined parameter may correspond to a combination of the radiation power value and the magnetic field strength. Now, a coarse control may be performed based on the radiation power value while a fine control may then be based on the external magnetic field strength. This option is preferred in terms of stability and power consumption. Nevertheless, the reverse option is also possible. The magnetic field strength may, for example, be varied by varying a coil current of a magnetic head of the readout system. Of course, as mentioned above, both parameters may be used in combination, that is, to implement a combined coarse and fine control function.

Furthermore, the control information may be obtained from a deviation of a maximum value of a phase error of a recovered clock signal from a predetermined set value. The predetermined additional change pattern may be a periodic pattern of a predetermined frequency. In particular, the periodic pattern may be a sinusoidal pattern so as to provide easy lock-in detection. Alternatively, the periodic pattern may be a square-wave pattern, preferably at half of the bit frequency or an integer multiple of half of the bit frequency, this has the advantage that it is easy to implement in the laser or coil driver circuitry.

The external magnetic field may be sustained by a field control means until the mark region is copied and may then be reversed in response to detection of the readout pulse.

Other advantageous embodiments are defined in the dependent claims.

In the following, the present invention will be described on the basis of a preferred embodiment and with reference to the accompanying drawings, in which:

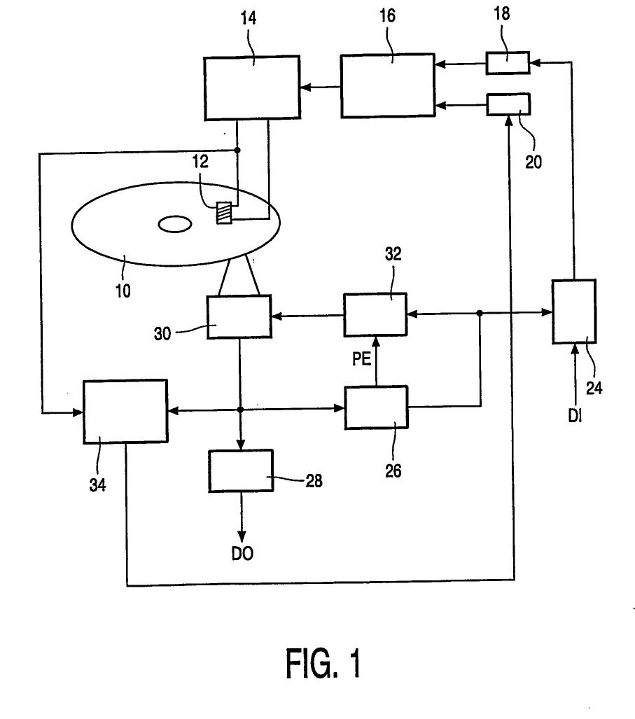

FIG. 1 shows a diagram of a magneto-optical disk player according to a preferred embodiment;

FIG. 2 shows a typical stack of a recording layer and of a readout layer in a magnetic super resolution (SR) medium;

FIG. 3 shows typical crescent shaped domain regions formed in the storage layer,

FIG. 4 shows a diagram indicating a characteristic of the magnetization of the recording layer as a function of the temperature;

FIG. 5 shows a diagram indicating a characteristic of the coercivity of the readout layer as a function of the temperature;

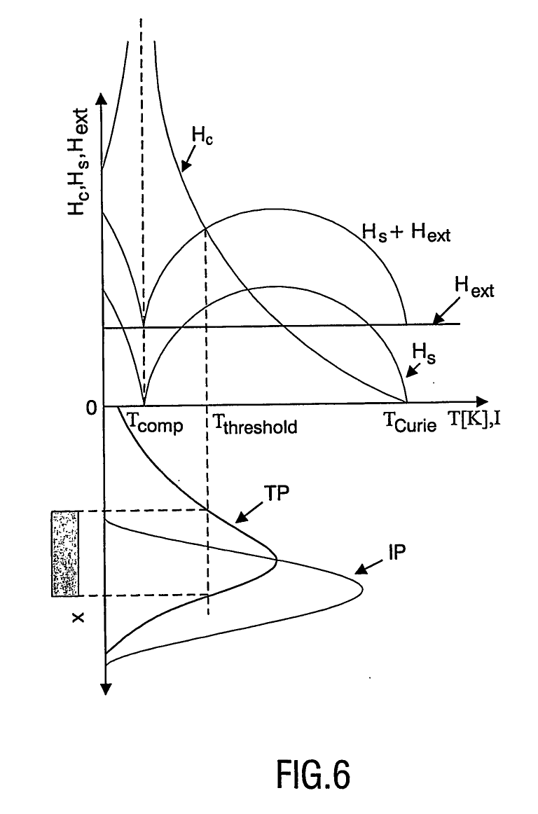

FIG. 6 is a schematic representation of the sensitivity of the copy window size as a function of the coercivity, the external magnetic field, and the laser power;

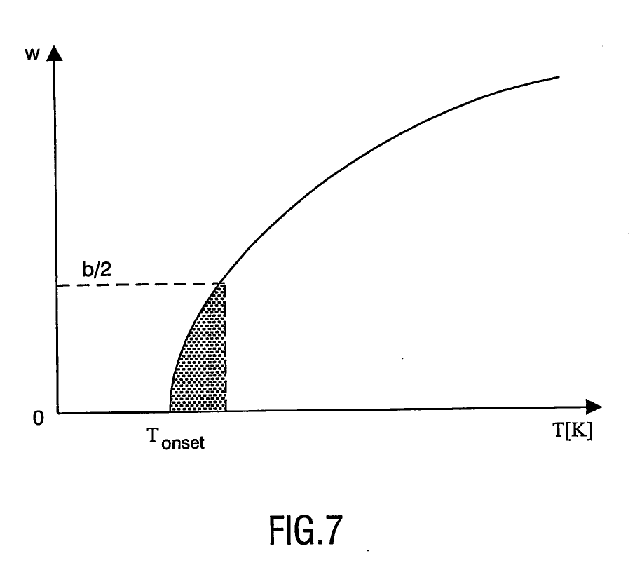

FIG. 7 shows a diagram indicating a characteristic of the copy window size as a function of the temperature;

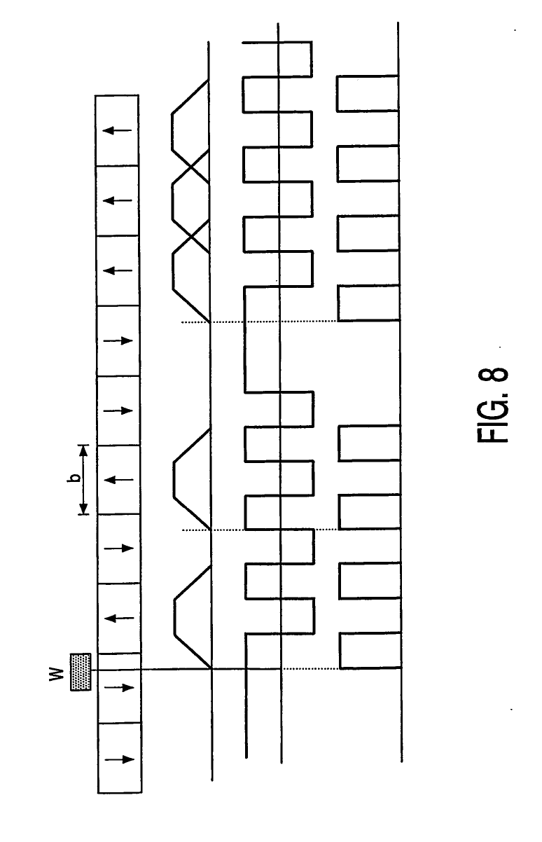

FIG. 8 shows readout signals for constant reading parameters and a small copy window size equal to b/2;

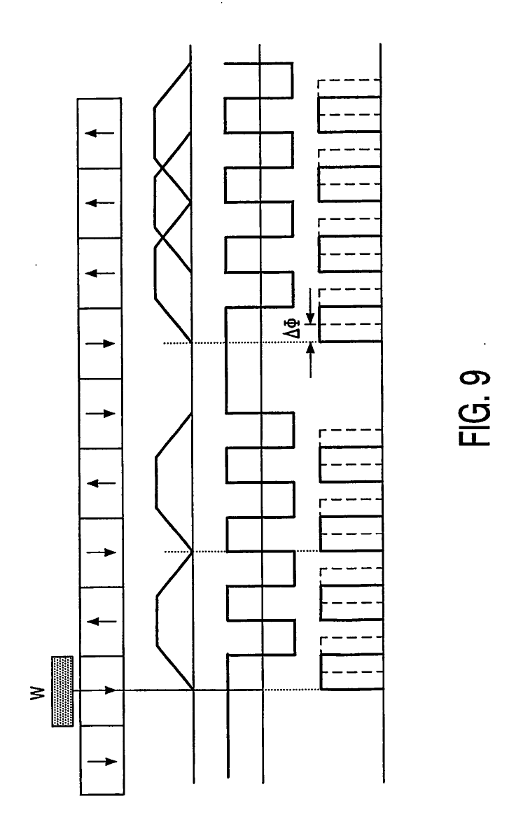

FIG. 9 shows readout signals for an increased copy window size;

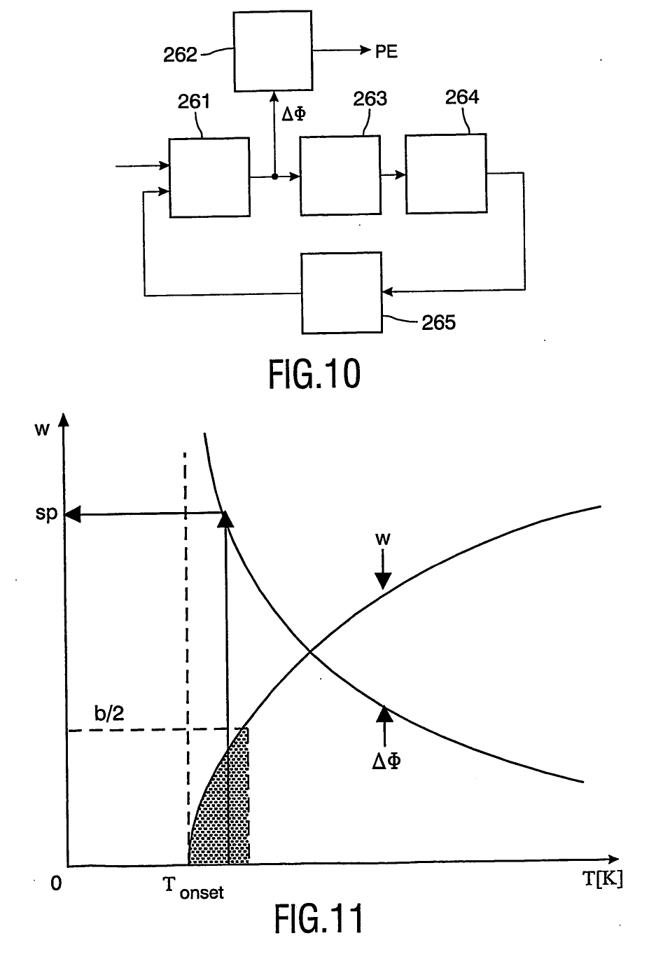

FIG. 10 shows a block diagram of a clock recovery circuit according to a preferred embodiment; and

FIG. 11 shows a diagram indicating a characteristic of the copy window size and a phase error amplitude as a function of the threshold temperature.

A preferred embodiment will now be described on the basis of a MAMMOS disk player as shown in FIG. 1.

FIG. 1 schematically shows the construction of the disk player according to a preferred embodiment. The disk player comprises an optical pick-up unit 30 having a laser light radiating section for irradiation of a magneto-optical recording medium or record carrier 10, such as a magneto-optical disk, with light that has been converted, during recording, into pulses with a period synchronized with code data, and a magnetic field applying section comprising a magnetic head 12 which applies a magnetic field in a controlled manner at the time of recording and playback on the magneto-optical disk 10. In the optical pick-up unit 30 a laser is connected to a laser driving circuit which receives recording and readout pulses from a recording/readout pulse adjusting unit 32 to thereby control the pulse amplitude and timing of the laser of the optical pick-up unit 30 during a recording and readout operation. The recording/readout pulse adjusting circuit 32 receives a clock signal from a clock generator 26 which may comprise a PLL (Phase Locked Loop) circuit.

It is to be noted that for reasons of simplicity the magnetic head 12 and the optical pick-up unit 30 are shown on opposite sides of the disk 10 in FIG. 1. However, according to the preferred embodiment they should be arranged on the same side of the disk 10.

The magnetic head 12 is connected to a head driver unit 14 and receives, at the time of recording, code-converted data via a phase adjusting circuit 18 from a modulator 24. The modulator 24 converts input recording data into a prescribed code.

At the time of playback, the head driver 14 receives a timing signal via a playback adjusting circuit 20 from a timing circuit 34, the playback adjusting circuit 20 generating a synchronization signal for adjusting the thing and amplitude of pulses applied to the magnetic head 12. The timing circuit 34 derives its timing signal from the data readout operation as described later. Thus, data-dependent field switching can be achieved. A recording/playback switch 16 is provided for switching or selecting the respective signal to be applied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to decode the reading signal to generate output data. Furthermore, the reading signal generated by the optical pick-up unit 30 is applied to a clock generator 26 in which a clock signal obtained from embossed clock marks of the disk 10 is extracted or recovered, and which applies the clock signal for synchronization purposes to the recording pulse adjusting circuit 32 and the modulator 24. In particular, a data channel clock may be generated in the PLL circuit of the clock generator 26. It is to be noted that the clock signal obtained from the clock generator 26 may as well be applied to the playback adjusting circuit 20 to thereby provide a reference or fallback synchronization which may support the data-dependent switching or synchronization controlled by the timing circuit 34.

In the case of data recording, the laser of the optical pick-up unit 30 is modulated with a fixed frequency corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The recording data are modulated and code-converted by the modulator 24 to obtain a binary run length information corresponding to the information of the recording data.

The structure of the magneto-optical recording medium 10 may correspond to the structure described in JP-A-2000-260079.

In the preferred embodiment shown in FIG. 1, the timing circuit 34 is provided for applying a data-dependent timing signal to the playback adjusting circuit 20. As an alternative, the data-dependent switching of the external magnetic field may as well be achieved by applying the timing signal to the head driver 14 so as to adjust the timing or phase of the external magnetic field. The timing information is obtained from the (user) data on the disk 10. To achieve this, the playback adjusting circuit 20 or the head driver 14 is adapted to provide an external magnetic field which is normally in the expansion direction. When a rising signal edge of a MAMMOS peak is detected by the timing circuit 34 at an input line connected to the output of the optical pick-up unit 30, the timing signal is applied to the playback adjusting circuit 20 such that the head driver 14 is controlled to reverse the magnetic field after a short time so as to collapse the expanded domain in the readout layer, and reset the magnetic field to the expansion direction shortly after that. The total time between the peak detection and the field reset is set by the timing circuit 34 to correspond to the sum of the maximum allowed copy window and one channel bit length on the disk 10 (times the linear disk velocity).

A dynamic copy window control function according to a preferred embodiment will be described hereinafter. FIG. 6 is a schematic representation of the sensitivity of the copy window size as a function of the coercivity, the external magnetic field, and the laser power. From experiments it appeared that for robust read-out of the domains the laser power must be controlled with an accuracy better than 0.8%. As indicated in FIG. 6, the threshold temperature for the copying process is determined at the point where the sum of the stray field H_{S} and of the external field Hₑₓₜ equals the coercivity H_{c}. In the lower part of the diagram a temperature profile TP and an intensity profile IP of the optical spot are plotted in the tangential direction of the disk track. Due to the movement of the disk, the temperature profile TP has an asymmetrical shape and the intensity profile IP slightly advances the temperature profile in the disk movement direction. The size of the copy window w is then determined by the width of the temperature profile TP at the threshold temperature T_{threshold}, as indicated by the grey rectangular area in the lower left part of FIG. 6.

As a first-order model, the top of the temperature profile TP can be regarded as a parabola (note that only the top of the temperature profile is used to achieve the required high resolution read-out). This can be expressed as follows:
T(x)=ax²+bx+c
The width of the copy window is now a square-root function depending on the threshold temperature T_{threshold}, as expressed by the following equation:

$${w}_{x} = \frac{\sqrt{{b}^{2} - 4 a c + 4 a {T}_{threshold}}}{a}$$

The onset temperature for the copy window to occur is now:

$${T}_{threshold} = c - \frac{{b}^{2}}{4 a}$$

The above function wₓ(T) is schematically represented in FIG. 7. The hatched region is the proper working range for MAMMOS readout where no interference peaks will occur, if the system is properly synchronized. As can be gathered from FIG. 7, the size w of the copy window increases according to a square-root function, while the amount of change of the copy window size w, i.e. the tangential slope or derivative of the graph, depends on the actual threshold temperature. This fact can be used to provide a copy window control functionality as follows.

The solution proposed here is to measure the size w of the copy window continuously by using information from the detected data signal in the read mode. FIG. 8 shows some key signals for readout of MAMMOS disks in a steady-state situation with constant laser power, constant ambient temperature, homogeneous disk properties, constant field strength, constant coil-disk distance, etc. The top graph shows the magnetic bits in the storage layer. The second graph shows the overlap signal (convolution) of the magnetic bit pattern and the copy window. The third graph shows the external magnetic field, and the bottom graph shows the resultant MAMMOS signal. When the overlap signal is non-zero, copying of domains will take place. As already mentioned, the external magnetic field is kept high until a bit or domain is copied from the storage layer and expanded in the readout layer. Then, after a fixed delay, the external field is reversed and the domain is collapsed until the next bit transition or domain copying occurs.

FIG. 9 shows a diagram similar to FIG. 8, but now one of the parameters to be controlled, e.g. the laser power, is increased deliberately. This increase/decrease (wobbling) is done with a predefined change pattern, e.g. a periodic pattern with a small amplitude. The wobbling causes the copy window to increase or decrease in size in synchronism with the wobble frequency. Comparing FIGS. 8 and 9, it becomes clear that when the copy window increases in size, the next transition will appear somewhat earlier than expected. On the other hand, when the copy window decreases in size, the next transition will be delayed slightly. This is the phase error Δφ shown in FIG. 9. However, as can be gathered from FIG. 7, the increase or decrease of the copy window size, and hence the value of the phase error Δφ, depends on the actual threshold temperature.

When the wobble frequency lies above the bandwidth of the clock recovery PLL circuit of the clock generator 26, the phase error of this PLL circuit can be used to detect the small deviation or phase error Δφ from the expected transition position. The average value of the frequency deviation of the introduced wobble or change pattern should be zero.

FIG. 10 shows an example of the PLL circuit of the clock generator 26 according to the preferred embodiment. The detected run length signal output from the pickup unit 30 is applied to a phase detector 261 in which the phase of the run length signal is compared with the phase of a feedback signal obtained from a clock divider 265 to which the output signal of a voltage-controlled oscillator (VCO) 264 is applied. The output of the phase detector 261, corresponding to the phase difference between the run length signal and the feedback signal, is applied to a loop filter 263 for extracting the desired frequency to be phase-controlled in the PLL circuit. A band-pass filter 262 with a center frequency around the wobble frequency can be used for low-noise detection of the phase error Δφ, i.e. lock-in detection. The phase error Δφ obtained here cannot be used yet as an absolute error signal for laser power control as only the absolute scale is known, but no reference (zero or offset) is present. This means that only changes in the size of the copy window can be measured.

To circumvent this problem, the derivative of the copy window size w a function of temperature can be measured to obtain a control information for controlling the size of the copy window.

FIG. 11 shows the derivative of the copy window characteristic of FIG. 7. Due to the fact that the derivative or amount of change of the copy window size directly leads to the phase error Δφ, the amplitude of the detected phase error Δφ corresponds to the derivative and hence can be used for copy window control. As a reference condition, this amplitude of the phase error Δφ must satisfy an initially determined set condition or setpoint sp. The deviation from this setpoint sp can then be used as a control signal PE for the laser power control procedure or for controlling any other suitable reading parameter, e.g. strength of the external magnetic field.

Any changes in the size w of the copy window due to changes in parameters, such as coil-disk distance, ambient temperature, etc., are counteracted by the controlled parameter, e.g. laser power in the present example.

However, when the laser power is controlled, the system might suffer from a slight thermal memory that causes a phase shift of the applied wobble signal. In principle, this shift can be compensated for by introducing a delay in the control loop, which should be a function of the disk velocity and also depends on the disk stack (thermal design). As an alternative, the field strength of the external magnetic field might be used as a control parameter, e.g. by varying the coil current. It is to be noted that this control is equivalent to that given by the relation as depicted in FIG. 6, since the threshold temperature is also shifted in response to the strength of the external magnetic field Hₑₓₜ. The described idea will not change significantly in that case.

It is to be noted that the present invention can be applied to any reading system for domain expansion magneto-optical disk storage systems. Any suitable reading parameter can be varied to control the copy window size. Furthermore, any suitable change pattern can be applied to the selected reading parameter so as to induce the phase error of the readout signal. The preferred embodiment may thus vary within the scope of the attached claims.

1. A reading method for reading a magneto-optical recording medium, comprising a storage layer and a readout layer, wherein an expanded domain leading to a readout pulse is generated in said readout layer by copying a mark region from said storage layer to said readout layer upon heating by a radiation power and with the aid of an external magnetic field, said method comprising the steps of:
a) controlling the size of a spatial copy window of said copying process by varying a predetermined reading parameter in response to a control information derived from said readout pulse,
b) applying a predetermined additional pattern of change to said predetermined parameter, and
c) obtaining said control information from a deviation of a clock signal.

2. A method according to claim 1, wherein said clock signal is recovered from said readout pulse, from a wobbled groove, or from embossed marks provided on said recording medium, or from any combination thereof.

3. A method according to claim 1, wherein said predetermined parameter corresponds to the value of said radiation power.

4. A method according to claim 1, wherein said predetermined parameter corresponds to the strength of said external magnetic field.

5. A method according to claim 1, wherein said predetermined parameter corresponds to a combination of the value of said radiation power and the strength of said external magnetic field.

6. A method according to claim 5, wherein one of said values of said radiation power and said strength of said external magnetic field is used for coarse control and the other one is used for fine control.

7. A method according to claim 4, wherein said strength of said external magnetic field is varied by varying a coil current of a magnetic head.

8. A method according to claim 1, wherein said control information is obtained from a deviation of a maximum value of a phase error of said recovered clock signal from a predetermined set value.

9. A method according to claim 1, wherein said predetermined additional change pattern is a periodic pattern of a predetermined frequency.

10. A method according to claim 9, wherein said periodic pattern is a sinusoidal pattern.

11. A method according to claim 9, wherein said periodic pattern is a square-wave pattern.

12. A method according to claim 11, wherein the frequency of said square-wave pattern corresponds to half of a bit frequency or an integer multiple of half of the bit frequency.

13. A method according to claim 1, wherein said clock signal is recovered by using a phase-locked loop function.

14. A reading apparatus for reading from a magneto-optical recording medium comprising a storage layer and a readout layer, wherein an expanded domain leading to a readout pulse is generated in said readout layer by copying a mark region from said storage layer to said readout layer upon heating by a radiation power and the aid of an external magnetic field, said apparatus comprising:
a) control means for controlling the size of a spatial copy window of said copying process by varying a predetermined reading parameter in response to a control information derived from said readout pulse,
b) change means for applying a predetermined additional pattern of change to said predetermined parameter, and
c) clock recovery means for obtaining said information from a deviation of a clock signal.

15. A reading apparatus according to claim 14, wherein said clock recovery means is arranged to recover said clock signal from said readout pulse, from a wobbled groove, or from embossed marks provided on said recording medium, or from any combination thereof.

16. A reading apparatus according to claim 14, wherein said control means is arranged to vary said radiation power.

17. A reading apparatus according to claim 14, wherein said control means is arranged to vary said external magnetic field.

18. A reading apparatus according to claim 14, wherein said control means is arranged to vary the value of said radiation power and the strength of said external magnetic field in combination.

19. A reading apparatus according to claim 18, wherein said control means is arranged to use one of said values of said radiation power and said strength of said external magnetic field for coarse control and the other one for fine control.

20. A reading apparatus according to claim 14, also comprising field control means for sustaining said external magnetic field until said mark region is copied and for reversing said external magnetic field in response to detection of said readout pulse.

21. A reading apparatus according to claim 14, wherein said clock recovery means is arranged to obtain said control information from a deviation of a maximum value of a phase error of said clock signal from a predetermined set value.

22. A reading apparatus according to claim 14, wherein said clock recovery means comprises a phase-locked loop circuit.

23. A reading apparatus according to claim 14, wherein said change means is arranged to use a periodic pattern of a predetermined frequency as said predetermined additional change pattern.

24. A reading apparatus according to claim 23, wherein said periodic pattern is a sinusoidal pattern.

25. A reading apparatus according to claim 23, wherein said periodic pattern is a square-wave pattern.

26. A reading apparatus according to claim 25, wherein the frequency of said square-wave pattern corresponds to half of a bit frequency or an integer multiple of half of the bit frequency.

27. A reading apparatus according to claim 14, wherein said reading apparatus is a disk player for MAMMOS disks.
